(19) United States
(12) Patent Application Publication
(10) Pub. No.: US 2008/0075859 A1
(43) Pub. Date: Mar. 27, 2008

(54) Printing, Depositing, or Coating On Flowable Substrates

(76) Inventors: Richard J. Baker, West Lebanon, NH (US); Edward T. Chrusciel, Nashua, NH (US)

Correspondence Address: FISH & RICHARDSON PC, P.O. BOX 1022, MINNEAPOLIS, MN, 55440-1022, US

(21) Appl. No.: 11/775,530

(22) Filed: Jul. 10, 2007

Related U.S. Application Data
(63) Continuation-in-part of application No. 11/560,493, filed on Nov. 16, 2006.
Application No. 11/560,493 is a continuation of application No. 10/761,008, filed on Jan. 20, 2004.

(51) Int. Cl. B05D 3/12; B29C 47/00

(52) U.S. Cl. 427/275; 118/46; 425/105; 118/300

(57) ABSTRACT

Printing, depositing, or coating on a flowable substrate can include extruding a flowable non-food substrate on a support, and jetting fluid to form an image on the flowable substrate.

### RELATED APPLICATIONS

This application is a continuation-in-part (and claims the benefit of priority under 35 U.S.C. 120) of U.S. application Ser. Nos. 10/761,008 and 11/560,493, filed on Jan. 20, 2004 and Nov. 16, 2006 respectively. The disclosure of the prior applications are considered part of (and are incorporated by reference in) the disclosure of this application.

### BACKGROUND

Ink jet printers are one type of apparatus for depositing drops of colorants or materials on a substrate. Ink jet printers typically include an ink path from an ink supply to a nozzle path. The nozzle path terminates in a nozzle opening from which ink drops are ejected. Ink drop ejection is typically controlled by pressurizing ink in the ink path with an actuator, which may be, for example, a piezoelectric deflector, a thermal bubble jet generator, or an electrostatically deflected element. A typical print assembly has an array of ink paths with corresponding nozzle openings and associated actuators. Drop ejection from each nozzle opening can be independently controlled. In a drop-on-demand print assembly, each actuator is fired to selectively eject a drop at a specific pixel location of an image as the print assembly and a printing substrate are moved relative to one another. In high performance print assemblies, the nozzle openings typically have a diameter of 50 microns or less, e.g. around 25 microns, are separated at a pitch of 100-300 nozzles/inch, have a resolution of 100 to 3000 dpi or more, and provide drops with a volume of about 1 to 120 picoliters (pl) or less. Drop ejection frequency is typically 10 kHz or more.

A piezoelectric actuator has a layer of piezoelectric material, which changes geometry, or bends, in response to an applied voltage. The bending of the piezoelectric layer pressurizes ink in a pumping chamber located along the ink path. Piezoelectric ink-jet print assemblies are also described in Fishbeck et al U.S. Pat. No. 4,825,227, Hine U.S. Pat. No. 4,937,598, Moynihan et al. U.S. Pat. No. 5,659,346 and Hoisington U.S. Pat. No. 5,757,391, the entire contents of which are hereby incorporated by reference.

### SUMMARY

In an aspect, printing, depositing, or coating on a flowable substrate can include extruding a flowable non-food substrate on a support, and jetting fluid to form an image on the flowable substrate.

Implementations may include one or more of the following features. The flowable substrate (e.g., viscoelastic material or molten plastic) can be transformed into a solid state after jetting fluid on the flowable substrate (e.g., placing the flowable substrate in a water bath). An ink jet printer can jet fluid. The flowable substrate can move along a conveyor or the flowable substrate can be extruded through a die to form an extrudate.

The substrate can be formed into individual articles. The fluid can include ink droplets. The flowable substrate can have a viscosity of about 30,000 Poise or less.

In another aspect, printing, depositing, or coating can include depositing a layer of a flowable non-food substrate on an article, and jetting fluid (e.g., ink droplets) to form a pattern on the flowable substrate layer.

Implementations can include one or more of the following features. The flowable substrate layer can have a viscosity of about 30,000 Poise or less. The flowable substrate layer can be cured from a flowable state into a solid state after jetting fluid droplets on the flowable layer. The flowable layer and pattern can form a surface, and a second flowable substrate layer is coated on the surface. Fluid can be jetted to form a second pattern on the second flowable layer. The flowable layers can be cured after jetting the second pattern on the surface. The patterns and layers can form a wood grain, texture, or decorative pattern. The flowable substrate can be a member selected from the group consisting of coatings (e.g. dielectric material), glazes, paints, and varnishes. The article can include wood (e.g., density fiber board wood), plastic, metal, or ceramic.

In an aspect, printing, depositing, or coating can include applying powder on a surface of a support, jetting fluid on the powder on the support, and causing the powder to flow and coat the surface of the support.

In another aspect, depositing jetting fluid on a powdered surface of a substrate can include an ink jet printer to jet fluid on a substrate in a pattern, a support for a substrate adjacent to the ink jet printer so that the ink jet printer can jet fluid on the substrate, and a station for dispensing powder on a surface of the substrate upstream from the ink jet printer.

Implementations can include one or more of the following features. The powder (e.g., a thermoset or thermoplastic material) can be electrostatically applied to the surface of a substrate or support (e.g. metal). The fluid can be jetted using a piezoelectric printhead. A station can cause the powder to flow and cover the surface of the substrate.

In another aspect, jetting fluid on a flowable non-food substrate can include an ink jet printer to jet fluid on a substrate in a pattern, a support for a flowable non-food substrate adjacent to the ink jet printer so that the ink jet printer can jet fluid on the flowable substrate, and an extruder configured to extrude the flowable substrate onto the support upstream from the ink jet printer.

Implementations can include one or more of the following features. A curing station can cure the flowable substrate downstream from the ink jet printer. A forming station can form the flowable substrate into individual articles.

Embodiments may include one or more of the following advantages. A high resolution, multicolor image can be formed or a functional material may be deposited (an Image) on a delicate surface in a flowable state. The Image can be quickly and inexpensively rendered using a drop-on-demand printing apparatus. The content of the Image can be selected immediately prior to printing. The Image can be customized to identify the product, the producer, or the consumer. By printing an Image on the substrate while it is flowable, the jettable material may adhere better because the surface energy of a flowable substrate may be lower than a solid substrate. For example, the jettable material can be incorporated into the substrate and does not easily scratch off the surface of the substrate. Since ink jet printing techniques allow printing of a substrate while it is in its flowable form, an ink jet printer can be incorporated into a production line. As such, substrates are printed as they come out of an extruder, after being sprayed with a coating, or prior to dicing or assembling a material into its final form. It is not necessary to wait until the product on the production line is cooled or dried to print on the substrates. This can enable the use of existing cooling and drying processes of an established production line to dry, cure, or incorporate the deposited ink or materials.

Still further aspects, features, and advantages follow. For example, combinations and ranges of, e.g. flowability, viscosity, resolution, substrate types and other parameters are described below.

### DESCRIPTION OF DRAWINGS

FIG. 1 shows a system for extruding, printing, and curing a flowable substrate.

FIG. 1A shows a flowable article including a printed image.

FIG. 2 shows a system for depositing multiple layers to build multilayered images.

FIG. 3 is a cross-sectional view of a printhead module.

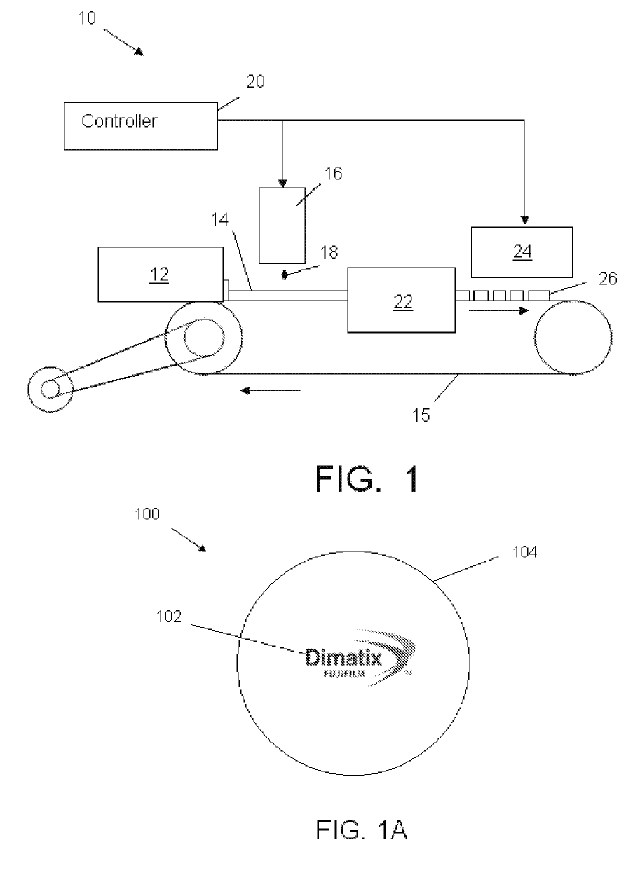

Referring to FIG. 1, a system 10 includes an extruder 12 for extruding a flowable substrate 14 (i.e. non-food product) on a support 15 (e.g., conveyor). A jetting assembly 16 (e.g., a piezoelectric or thermal ink jet printhead) jets fluid droplets 18 (e.g., ink) to form an image (e.g., text, graphic, or pattern) on the flowable substrate 14. A controller 20 sends image data to the printhead and can also store images. Ink jet printing allows the user to change the printed image on each substrate in real time. The support 15 moves the flowable substrate with the printed image to a curing station 22 to either transform the flowable substrate 14 into a solid, cure the printed image, or both. When the flowable substrate is a web or a sheet of material, a cutting station 24, optionally controlled by controller 20, can cut the web into individual articles 26 (e.g. promotional products). The flowable substrate can also be extruded through a die to form an extrudate, the die can mold the extrudate into a desired shape. During printing, the substrate is in a state in which it has, for example, a delicate, easily damaged surface that is, typically, flowable. For example, the substrate can be a liquid, molten material, or powder.

The flowability, stability, and/or viscosity can be a characteristic of the flowable substrate in the state in which it is extruded or deposited, or the product can be treated, e.g. heated or cooled, prior to or during printing, to establish a desired flowability or viscosity at the moment of printing. A flowable substrate is a substrate in a state that is neither a gas nor a solid, e.g. a liquid, paste, slurry, powder, suspension, colloid, viscoelastic material, or molten material. The flowable substrate may be deposited and flowable at room temperature (e.g., about 20° F. to 25° F.) or the flowable substrate can be heated to an elevated temperature, such as its melting point, softening temperature, or glass transition temperature.

For example, plastic can have a melting point between about 120° C. to about 350° C. depending on the type of plastic. Polyvinyl chloride (PVC) has a glass transition temperature of about 80° C. and a melting point of about 210° C. At the glass transition temperature, PVC moves from a glassy, solid state to a rubbery state that is more flexible and deformable. If the heat increases to the melting point, the PVC moves from a rubbery state into a liquid state. In embodiments, the flowable substrate becomes substantially solid in its final state but is in a flowable viscosity state for imaging. Examples of flowable substrates include molten plastic or glass, varnishes, coatings (e.g., dielectric material), paints, glazes, pastes, slurries, adhesives, powders, foams or other substrates that are neither in a gas state nor a solid state.

Referring to FIG. 1, the flowable substrate 14, such as plastic (e.g., PVC) in a viscoelastic state, can be extruded through a die, which shapes the extrudate into a desired shape. For example, the extrudate can be shaped into individual window slats used to make Venetian window blinds. A wood grain pattern can be printed on the viscoelastic plastic before it is cooled, for example, in a water bath. Other implementations can include depositing solar cells or printable batteries on window blinds, such that the cells or batteries are embedded in the blinds when the material is in a melted, flowable state. Scratch resistant coatings can also be applied to the blinds before the material cools and hardens. FIG. 1A shows molten plastic 104 after it has been extruded and cut to form a promotional product 100 that is printed with an image 102 (e.g. FUJIFILM DIMATIX). The molten plastic can be extruded through a die and printed while it is still hot and pliable. A cure station can cool the molten plastic and transform it into a solid. Other products (e.g. pens, food containers, vinyl siding, tubing, water bottles, letter openers, or cups) can be printed on in a flowable state to identify the producer or the consumer, or can be decorative. A cutting station can be used to cut individual articles out of a sheet of plastic either before or after printing.

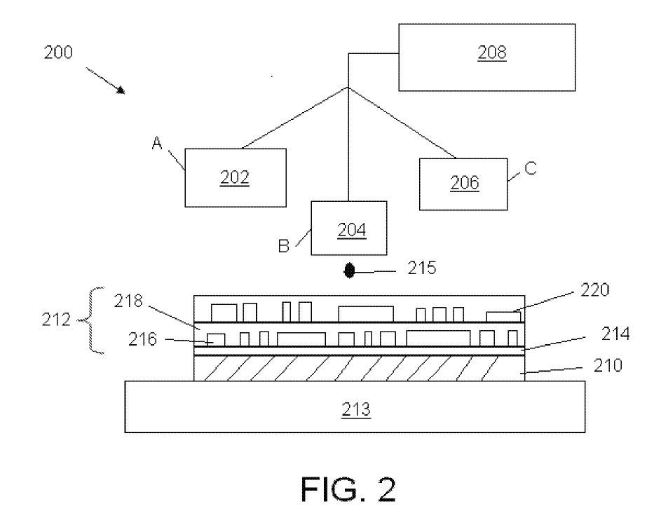

Referring to FIG. 2, a system 200 includes a coating device 202, jetting assembly 204, and curing device 206 that are connected to a controller 208 that moves each device relative to an article 210 on a support 213 (e.g. stationary platen or conveyor), from an active position to an idle position. In FIG. 2, the coating device 202 and the curing device 206 are in idle positions A and C while the jetting assembly 204 is printing on the article in an active position B. The system 200 can build a multilayered image 212 on the article 210 (e.g. web or discrete product) by alternating between printing patterns and depositing coatings.

In an example, the curing device 206 and jetting assembly 204 start in idle positions A and C and the coating device 202 is in active position B. The coating device 202 deposits a layer of a flowable substrate 214 (e.g. varnish) on the article 210. When the coating is complete, the coating device moves from B to idle position A, the jetting assembly 204 moves from idle position C to the active position B, and the curing device moves from idle position A to idle position C. In active position B, the jetting assembly ejects fluid droplets 215 to form a first pattern 216 on the flowable substrate layer 214. The curing device 206 then moves from idle position C to active position B and cures the first pattern 216, the flowable substrate 214, or both. A second flowable layer 218 and pattern 220 can be deposited on the first flowable layer 214 and so on to create a multilayered image 212.

For example, a multigrain wood pattern can be ink jet printed onto flooring, cabinets, or furniture, such as medium density fiber board wood (MDF). First, a layer of varnish (i.e., polyurethane or oil-based) is applied to the MDF wood. Second, a wood grain pattern is ink jetted on the varnish while the varnish is still wet or tacky. These steps are repeated to create a wood grain appearance with depth. The varnish and ink can be cured in between applying layers or as a final step after all the layers are deposited.

Another example is creating decorative ceramic tiles using a similar process of applying a glaze on a ceramic tile, jetting a pattern on the flowable glaze, and firing the glaze after the pattern is printed. An ink jet printer prints on the glaze while it is still wet before it is dried, cured, or fired. The steps can also be repeated to create a multilayered image. Each layer of glaze with the printed pattern can be fired after it is applied or all the layers can be fired together at the end.

Instead of building multilayered images, a single flowable substrate layer and image can be printed using either single-pass or scanning mode.

The coating device 202 in FIG. 2 can deposit a powder (e.g. thermoset or thermoplastic polymer) on a surface, and an image can be printed on the powder prior to transforming the powder into a solid. Powders can be used to paint metals (e.g. saw blades) rather than using a typical solvent paint. The powder is electrostatically applied to the saw blade, and an image (e.g., company logo) is jetted on the powder. The powder is then heated until it begins to flow and coat the surface of the saw blade. The powder transforms into a solid as it cools on the metal blade.

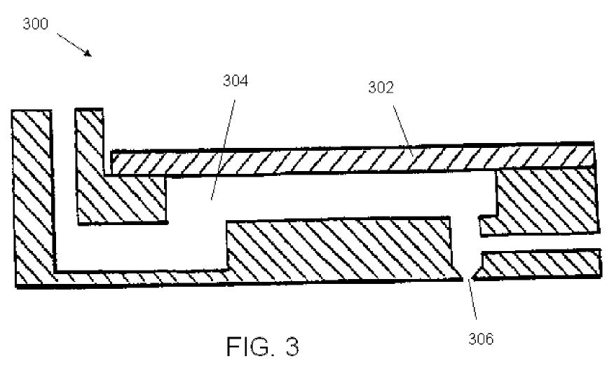

Referring to FIG. 3, an ink-jet printhead includes a series of modules for printing different colored inks (e.g., cyan, magenta, yellow, and black ink). The module 300 is preferably a drop-on-demand module including a piezoelectric element 302 which pressurizes ink in a pumping chamber 304 for ejection through a nozzle opening 306. In embodiments, the printhead includes a heater to heat the fluid to a desired viscosity to facilitate jetting. A suitable printhead is the NOVA or GALAXY printhead, available from FUJIFILM Dimatix, Inc., Santa Clara, Calif. Suitable piezoelectric inkjet printers are also discussed in Fishbeck '227, Hine '598, Moynihan '346 and Hoisington '391, incorporated, supra and WO 01/25018, the entire contents of which is hereby incorporated by reference.

Suitable images are produced by selecting the printing conditions so that the jetting fluid is ejected in the form of drops that prevent excessive splashing or cratering when the drops impact the flowable substrate surface and thus, the integrity of the image is maintained. For flowable substrates having a viscosity of about 50,000 cP or less, such as 2,500 cP or less, suitable drop sizes are about 200 pL or less, e.g., 60-100 pL. Higher viscosity flowable substrates, such as viscoelastic materials, can have a viscosity of about 30,000 Poise or less (e.g. 20,000 Poise or less or 10,000 Poise or less), and can also be printed with drop sizes of 200 pL or less, 60-100 pL. The velocity of the drops is about 2-12 m/sec, e.g. about 7-9 m/sec. The printing resolution is about 50 dpi or greater, e.g. about 150-500 dpi. In embodiments, the jetting fluid is heated, e.g. to about 40 to 125° C., to maintain a desired jetting viscosity, e.g. about 10-20 cP. Viscosity can be measured by using a rotating cylinder-type viscosometer. A suitable instrument is the Model DV-III Programmable Rheometer with Thermoset System 3 sample holder controlled by a Model 106 Programmable Temperature Controller, available from Brookfield, Middleboro, Mass. At 60 rpm with a #18 spindle, the system can measure viscosity up to about 49.9 cP. Higher viscosities can be measured with a parallel plate viscometer.

In embodiments, the viscosity of the substrate during printing is greater than the viscosity of water at room temperature. In other embodiments, the viscosity is greater than the viscosity of honey at room temperature. The viscosity of the jetting fluid can be adjusted relative to the viscosity of the substrate. For example, if the jetting fluid is miscible with the flowable substrate, then the jetting fluid should have a higher viscosity than the substrate to prevent the fluid from bleeding. If the jetting fluid is immiscible with the flowable substrate (i.e., oil varnish and water-based ink), then the jetting fluid needs a viscosity that avoids reticulation (i.e., the ink clumping together). To prevent reticulation, gelants can be added to the jetting fluid or a hot melt ink can be used.

In embodiments, a jetting fluid can include a solvent-based carrier which evaporates during jetting or after impacting the flowable substrate. In embodiments, the jetting fluid includes a meltable carrier which solidifies on the substrate. In embodiments, the jetting fluid can be UV curable fluid that solidifies when exposed to ultraviolet light. The viscosity of these jetting fluids is typically relatively low when ejected from the nozzle and on impact with the flowable substrate, which reduces splashing or cratering effects. The viscosity of the jetting fluid then increases, as the solvent carrier evaporates, the carrier solidifies, or the fluid is UV cured, which reduces spreading of the jetting fluid into the substrates. A suitable solvent carrier is a low molecular weight glycol ether acetate, e.g. DPMA (dipropylene glycol monomethyl ether acetate). A suitable meltable carrier is animal fat or a wax. In embodiments, the viscosity of the jetting fluid is about 20 cps or less during jetting, e.g. 10-20 cps, and the viscosity at substrate temperature is 20-200 cps or more. In embodiments, viscosity at jetting is 10-20 cps and the jetting fluid is heated to 40-125° C., e.g. the viscosity is 12-14 cps at 50 to 60° C. In embodiments, the solubility of the jetting fluid or major components of the fluid is low in the substrate to reduce diffusion of jetting fluid into the substrate. For substrates including non-polar, e.g. lipid ingredients, the jetting fluid or its major components are generally polar and have a high solubility, e.g. are miscible, in water. For example, in embodiments, the jetting fluid includes a highly water-soluble carrier that is e.g. 50%, or 70% or more of the jetting fluid. Suitable highly water soluble carriers include water, and alcohols. A suitable carrier is propylene glycol. For substrates that are substantially water soluble, the fluid can include a carrier that has low water solubility, such as animal fat. The media can also include colorants, such as organic dyes, stabilizers, flexibilizers, plasticizers, and/or other additives.

Referring to FIG. 1, the support can also be a stationary platen. In FIGS. 1 and 2, curing devices can include a heat source, water bath, kiln, ultraviolet light, cool air, flash freezer, or other devices for curing flowable substrates or jetting fluids. There can be more than one curing station (e.g. one curing station for ink and another one for curing the flowable substrate).

Referring back to FIG. 2, the coating station can deposit a flowable substrate layer by spraying, ink jetting, screen printing, extruding, dipping, sputtering or other deposition or printing methods.

There can be a number of printing stations.

Other embodiments are within the scope of the following claims. For example, method steps may be performed in a different order and still produce desirable results.

What is claimed is:

1. A method of printing, depositing, or coating on a flowable substrate comprising:
extruding a flowable non-food substrate on a support; and
jetting fluid to form an image on the flowable substrate.

2. The method of claim 1, further comprising transforming the flowable substrate into a solid state after jetting fluid on the flowable substrate.

3. The method of claim 2, wherein transforming comprises placing the flowable substrate in a water bath.

4. The method of claim 1, wherein the fluid is jetted using an ink jet printer.

5. The method of claim 1, further comprising moving the flowable substrate along a conveyor.

6. The method of claim 1, wherein the flowable substrate comprises a viscoelastic material.

7. The method of claim 6, wherein the viscoelastic material comprises molten plastic.

8. The method of claim 1, wherein the flowable substrate is extruded through a die to form an extrudate.

9. The method of claim 1, further comprising forming the substrate into individual articles.

10. The method of claim 1, wherein the fluid comprises ink droplets.

11. The method of claim 1, wherein the flowable substrate has a viscosity of about 30,000 Poise or less.

12. A method of printing, depositing, or coating comprising:
depositing a layer of a flowable non-food substrate on an article; and
jetting fluid to form a pattern on the flowable substrate layer.

13. The method of claim 12, wherein the flowable substrate layer has a viscosity of about 30,000 Poise or less.

14. The method of claim 12, further comprising curing the flowable substrate layer from a flowable state into a solid state after jetting fluid droplets on the flowable layer.

15. The method of claim 12, wherein the flowable layer and pattern form a surface, and a second flowable substrate layer is coated on the surface.

16. The method of claim 15, further comprising jetting fluid to form a second pattern on the second flowable layer.

17. The method of claim 16, further comprising curing the flowable layers after jetting the second pattern on the surface.

18. The method of claim 17, wherein the patterns and layers form a wood grain, texture, or decorative pattern.

19. The method of claim 12, wherein the fluid comprises ink droplets.

20. The method of claim 12, wherein the flowable substrate is a member selected from the group consisting of coatings, glazes, paints, and varnishes.

21. The method of claim 20, wherein the coatings comprise dielectric material.

22. The method of claim 12, wherein the article comprises wood, plastic, metal, or ceramic.

23. The method of claim 12, wherein the article comprises medium density fiber board wood.

24. A method of printing, depositing, or coating comprising:
applying powder on a surface of a support;
jetting fluid on the powder on the support; and
causing the powder to flow and coat the surface of the support.

25. The method of claim 24, wherein the powder is electrostatically applied to the support.

26. The method of claim 24, wherein the powder comprises a thermoset or thermoplastic material.

27. The method of claim 24, wherein the fluid is jetted using a piezoelectric printhead.

28. The method of claim 24, wherein the support comprises metal.

29. A system for jetting fluid on a flowable non-food substrate, comprising:
an ink jet printer to jet fluid on a substrate in a pattern;
a support for a flowable non-food substrate adjacent to the ink jet printer so that the ink jet printer can jet fluid on the flowable substrate; and
an extruder configured to extrude the flowable substrate onto the support upstream from the ink jet printer.

30. The system of claim 29, further comprising a curing station to cure the flowable substrate downstream from the ink jet printer.

31. The system of claim 29, further comprising a forming station to form the flowable substrate into individual articles.

32. A system for depositing jetting fluid on a powdered surface of a substrate, comprising:
an ink jet printer to jet fluid on a substrate in a pattern;
a support for a substrate adjacent to the ink jet printer so that the ink jet printer can jet fluid on the substrate; and
a station for dispensing powder on a surface of the substrate upstream from the ink jet printer.

33. The system of claim 32, further comprising a station to cause the powder to flow and cover the surface of the substrate.

34. The system of claim 32, wherein the powder is electrostatically applied to the surface of the substrate.
